(19) United States
(12) Patent Application Publication
(10) Pub. No.: US 2022/0124987 A1
(43) Pub. Date: Apr. 28, 2022

(54) LIGHT DIFFUSING REFLECTIVE CURTAIN FOR AGRICULTURAL ENVIRONMENT

(71) Applicant: W. L. Gore & Associates, Inc., Newark, DE (US)

(72) Inventors: Jeffrey B. Duncan, Flagstaff, AZ (US); Edward H. Cully, Flagstaff, AZ (US)

(21) Appl. No.: 17/429,436

(22) PCT Filed: Feb. 7, 2020
(86) PCT No.: PCT/US2020/017213

§ 371 Date: Aug. 9, 2021

Related U.S. Application Data
(60) Provisional application No. 62/803,162, filed on Feb. 8, 2019.

(51) Int. Cl. A01G 13/02; A01G 7/04

(52) U.S. Cl. CPC A01G 13/0206; A01G 7/045

(57) ABSTRACT

A controlled environment agriculture system is disclosed, in which the system includes a reflective curtain (100, 600) having a porous membrane with a reflectance value of at least 90%.

### CROSS-REFERENCE TO RELATED APPLICATION

The present application is a national phase application of PCT Application No. PCT/US2020/017213, internationally filed on Feb. 7, 2020, which, claims the benefit of U.S. Provisional Application No. 62/803,162, filed Feb. 8, 2019, the subject matter of which are expressly incorporated herein by reference.

### FIELD

The present disclosure relates generally to a light diffusing membrane, and more specifically to a controlled light diffusing reflective membrane for agricultural environments.

### BACKGROUND

Indoor agriculture has become more popular during the recent years for a variety of reasons. Indoor agriculture generally uses grow lighting, such as canopy lights. Subject to the specific species being grown, Plant growth typically results from the availability of a combination of nutrients, light, and carbon dioxide. Plants use chlorophyll and other pigments to absorb the energy from light and convert it into energy that the plants can use through photosynthesis. For example, chlorophyll a, which is in all plants, absorbs most energy from wavelengths of violet-blue and orange-red light spectrums. Therefore, agriculturers such as farmers can use their knowledge of plants and their pigments to adjust the specific grow lights to use in order to save energy as well as to alter the taste, nutrient value, and/or medicinal values of certain plants or organisms.

Specific kinds of indoor agriculture may use water in unique ways relative to outdoor agriculture. For example, hydroponic agriculture typically uses no soil in growing plants, but instead includes nutrients and minerals the plants need to grow in a water solvent to which the roots of the plants are exposed. Instead of soil, the plants are supported by an inert medium such as perlite or gravel. Also, a closed-loop irrigation system may be incorporated into some hydroponic operations. The closed-loop irrigation saves over half of water usage and reduces the amount of fertilizers used, while also preventing pollutants from entering the system, which can come from groundwater and soil.

Risk reduction can also be a major factor in the popularity of controlled environment agriculture. For example, when plants are grown in a traditional outdoor agricultural, there are greater risks of yield loss from pests, diseases, inclement weather, and other sources. Also, current practice in the business of produce transportation is to pick the produce, e.g. fruits, before it is ripe, so that the produce is ripened during the long transportation from the farm to the produce's respective destination. This is because if the produce is picked after it is ripened, the produce may become compromised during transportation, or otherwise have too short a shelf life. In addition, produce that is picked before ripening is known to be less nutritious than fresh produce that is allowed to ripen before being picked. Moreover, plants, which may yield edible vegetation and fruits, may be grown locally to reduce the distance from the food supply to the distributors, such restaurants, supermarkets, and local farmer's markets, thereby reducing shipping cost and helping to ensure freshness through local sourcing. Additionally, an indoor growing environment is generally cleaner than other methods, thus reducing the possibility of human error such as E. coli contamination.

### SUMMARY

Disclosed herein is an agriculture system in a controlled environment. According to one example (“Example 1”), the agriculture system includes a reflective curtain including a porous membrane having a reflectance value of at least 90%.

According to another example (“Example 2”) further to Example 1, the agriculture system further includes a light source and a photosynthetic organism arranged to receive light from the light source that is diffused by the reflective curtain.

According to another example (“Example 3”) further to Example 1 or 2, the membrane is permeable to air at an atmospheric pressure from about 980 mbar to about 1040 mbar.

According to another example (“Example 4”) further to any preceding Example, a first average reflectance value of the membrane at a first wavelength range from 400 nm to 450 nm is lower than a second average reflectance value at a second wavelength range from 450 nm to 750 nm.

According to another example (“Example 5”) further to any preceding Example, the reflectance value of the porous membrane is at least 95%.

According to another example (“Example 6”) further to Example 5, the reflectance value of the porous membrane is at least 98%.

According to another example (“Example 7”) further to any preceding Example, the membrane includes an expanded fluoropolymer.

According to another example (“Example 8”) further to Example 7, the expanded fluoropolymer is an expanded polytetrafluoroethylene (ePTFE).

According to another example (“Example 9”) further to any preceding Example, the agriculture system further includes a light source operably arranged adjacent the reflective curtain such that light is reflected by the reflective curtain.

According to another example (“Example 10”) further to any preceding Example, the reflective curtain forms an enclosure configured to cover a photosynthetic organism.

According to another example (“Example 11”) further to Example 3, the membrane is also permeable to at least one other gas.

According to another example (“Example 12”) further to Example 11, the other gas includes at least one of: hydrogen sulfide and ethylene.

According to another example (“Example 13”), a greenhouse includes at least one sidewall and a ceiling. The at least one sidewall and the ceiling at least partially includes a porous membrane having a reflectance value of at least 90%.

According to another example (“Example 14”), a compliant reflector for a light source includes a porous membrane having a reflectance value of at least 90%.

According to another example (“Example 15”), a self-cleaning reflector includes a porous membrane having a reflectance value of at least 90%. The reflector is cleanable by blowing air through the porous membrane.

According to another example (“Example 16”) further to Example 15, the self-cleaning reflector further includes a pressurized air source operably associated with the porous membrane that is configured to deliver pressurized air through the porous membrane for cleaning the porous membrane.

According to another example (“Example 17”), a spectral-specific greenhouse material includes a porous membrane having a reflectance value of at least 90%. A first average reflectance value of the membrane at a first wavelength range from 400 nm to 450 nm is lower than a second average reflectance value at a second wavelength range from 450 nm to 750 nm.

According to one example (“Example 18”) further to any one of Examples 1 to 12, the reflective curtain has a thickness from 0.100 mm to 0.400 mm.

According to one example (“Example 19”) further to any one of Examples 1 to 12 and 18, the reflective curtain has a drape coefficient of less than 0.4.

According to one example (“Example 20”) further to any one of Examples 1 to 12, 18, and 19, the reflective curtain has a density of less than 0.50 g/cc.

According to one example (“Example 21”) further to Example 9 or 10, the at least one light source is disposed on the reflective curtain, the reflective curtain further comprising at least one conductive trace array disposed thereon and operatively coupled with the at least one light source.

According to one example (“Example 22”) further to Example 21, the reflective curtain comprises two reflective layers at least partially bonded to each other, and the at least one light source and the at least one conductive trace are disposed between the two reflective layers of the reflective curtain.

According to one example (“Example 23”) further to Example 21 or 22, at least one location on the reflective curtain is more transparent than the rest of the reflective curtain, and the at least one light source is disposed at the at least one location.

According to one example (“Example 24”) further to Example 21 or 22, at least one location on the reflective curtain forms a lens, and the at least one light source is disposed at the at least one location.

According to one example (“Example 25”), a method of assembling a controlled environment agriculture system is disclosed. The method includes arranging a reflective curtain including a porous membrane having a reflectance value of at least 90% adjacent a plant and operating a light source to provide light that is reflected from the reflective curtain to the plant.

According to one example (“Example 26”) further to Example 25, operating the light source includes powering a light source included in the reflective curtain.

According to one example (“Example 27”) further to Example 26, the reflective curtain comprises at least one conductive trace array on a surface of the reflective curtain, the at least one conductive trace array operatively coupled with the light source.

According to one example (“Example 28”) further to Example 26 or 27, the reflective curtain further includes a first layer and a second layer at least partially bonded to each other such that the light source is disposed between the polymer film layer and the reflective curtain.

According to one example (“Example 29”) further to Example 28, a surface of at least one of the first and second layers is substantially transparent at a location where the light source is disposed.

According to one example (“Example 30”) further to any one of Examples 25 to 29, arranging the reflective curtain includes draping the reflective curtain such that ambient, positive pressure air flow causes the reflective curtain to deform and modify a surface angle of the reflective curtain relative to the plant.

According to one example (“Example 31”) further to Example 25, modifying the surface angle of the reflective curtain changes directions in which light is reflected or scattered by the reflective curtain.

According to one example (“Example 32”), a method of making a reflective curtain is disclosed. The method includes applying at least one conductive trace array on a surface of a first film having a reflectance value of at least 90%, disposing a light source on the surface of the first film, the at least one conductive trace array operatively coupled with the light source, applying adhesive on a surface of a second film, and forming the reflective curtain by at least partially bonding the surface of the first film with the surface of the second film such that the light source is disposed between the first and second films.

According to one example (“Example 33”) further to Example 32, the method further includes wetting the surface of the polymer film layer with a solvent. The surface of the polymer film is wetted at a location where the light source is to be disposed when the polymer film layer and the reflective curtain are at least partially bonded.

According to one example (“Example 34”) further to Example 32 or 33, the reflective curtain has a thickness from 0.100 mm to 0.400 mm.

According to one example (“Example 35”) further to any one of Examples 32 to 34, the reflective curtain has a drape coefficient of less than 0.4.

According to one example (“Example 36”) further to any one of Examples 32 to 35, the reflective curtain has a density of less than 0.50 g/cc.

According to one example (“Example 37”), a controlled environment agriculture system is disclosed, where the system includes a reflective curtain including a porous membrane having a reflectance value of at least 80% and a drape coefficient of less than 0.4.

According to one example (“Example 38”) further to Example 37, the reflective curtain has a thickness from 0.100 mm to 0.400 mm.

According to one example (“Example 39”) further to Example 37 or 38, the reflective curtain has a density of less than 0.50 g/cc.

According to one example (“Example 39”) further to one of Examples 37-39, the controlled environment agriculture system includes a light source and a photosynthetic organism arranged to receive light from the light source that is diffused by the reflective curtain.

According to one example (“Example 40”) further to Example 39, the photosynthetic organism is configured to change a position of the reflective curtain when the photosynthetic organism grows past a predetermined height or size.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 illustrates an agricultural environment where a material located between a light source and a plant achieves light diffusion in accordance with at least one embodiment;

FIG. 2 illustrates an agricultural environment where a material forming an enclosure for a light source and the plant achieves light reflectance in accordance with at least one embodiment;

FIG. 3A illustrates the different directions in which light travels on a surface due to diffusive reflectance in accordance with at least one embodiment;

FIG. 3B illustrates the relationship between incident light and diffuse light when the light is scattered due to diffusive reflectance in accordance with at least one embodiment;

FIG. 3C is a close-up view of a surface as disclosed herein that has a surface with high diffusive reflectance in accordance with at least one embodiment;

FIG. 4 is a graphical illustration showing the relationship between wavelength and reflectance for various materials as disclosed herein in accordance with at least one embodiment;

FIG. 5 is a graphical illustration showing the relationship between reflectance and the number of reflections that can be achieved by the reflectance, as well as the remaining light energy after each reflection in accordance with at least one embodiment;

FIG. 6 is a view of an indoor agricultural environment in accordance with an embodiment, where one of the two plants is enclosed by an ePTFE curtain, where the other is located outside the enclosure; and

FIG. 7 is a comparison view of the two plants grown in the environment according to FIG. 6 in accordance with at least one embodiment.

FIG. 8 is a graphical illustration showing a setup of a reflective curtain for a plant in accordance with at least one embodiment;

FIG. 9 is a partial view of a reflective curtain with a light source and a metal trace attached thereto in accordance with at least one embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

The term “diffusive transmission” as used herein refers to the passage or movement of light, or electromagnetic waves, through a material, after which the light is scattered, or the unidirectional beam is deflected into many directions. The term “diffusive transmittance” describes the effectiveness of the material in transmitting the radiant energy from the light.

As used herein, the term “diffusive reflection” refers to scattered reflection of light (e.g., originating from a unidirectional beam). As used herein, the term “diffusive reflectance” describes the effectiveness of the material in reflecting the radiant energy from light.

### Description of Various Embodiments

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting. It is also to be understood that the terms “photosynthetic organism” and “plant” may be interchangeably used herein.

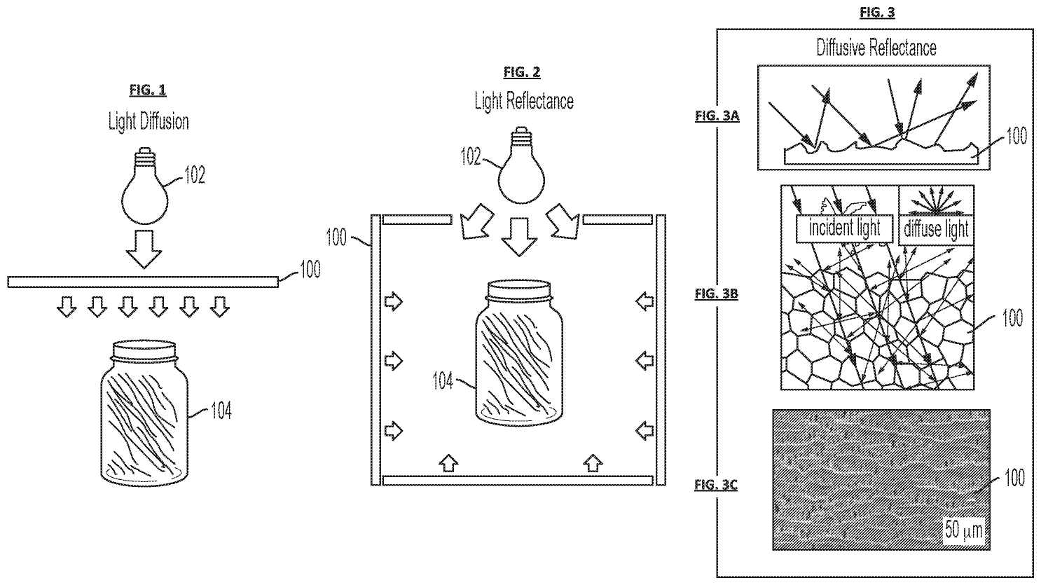

FIGS. 1 to 3 are illustrative of concepts relating to the optical properties and physical structures of reflective curtains, also described as light curtains, according to the instant disclosure. In FIGS. 1 and 2, a reflective curtain 100 is located between a light source 102 and a photosynthetic organism (e.g., plants, algae, bacteria, and phytoplankton) 104 which is to receive as much of the light from the light source 102 as possible. In FIG. 1, the reflective curtain 100 is placed linearly proximate to and between the light source 102 and the plant 104 such that the light is transmitted through the reflective curtain 100 and disperses on the other side of the reflective curtain 100, causing the plant 104 to uniformly or substantially uniformly receive light. Thus, in this example, the reflective curtain 100 has a high diffusive transmittance value. The reflective curtain 100 of FIG. 1 is analogous to a cover material used in a greenhouse which is located between the sun and the plant within the greenhouse to protect the plant from outside pests and other environmental factors that can be detrimental to the growth of the plant.

FIG. 2 shows an enclosure formed around the plant, where the enclosure is formed of the reflective curtain 100. In this case, the reflective curtain 100 has a high reflectivity such that light from the light source 102 is reflected off the surface of the reflective curtain 100 and toward the plant 104 from various directions. Specifically, the reflective curtain 100 in FIG. 2 has a high diffusive reflectance value for the plant to obtain as much light as possible from all directions. One of the advantages in having the configuration illustrated in FIG. 2 as compared to the configuration depicted in FIG. 1 is that the plant 104 can receive more light because of the reflections of light from an increased range of angles (e.g., greater than 180 degrees, greater than 270 degrees or up to 360 degrees). The reflective curtain 100 of FIG. 2 is used to contain and disperse sunlight that has entered the greenhouse or of light that is generated within the greenhouse environment. Examples of this process are shown in FIGS. 3A-3C.

FIGS. 3A-3C illustrate concepts relating to the diffusive reflectance of the reflective curtain 100. When a ray of light reflects off a surface, the direction in which the light travels varies depending on the angle of the surface at which the ray of light is reflecting. As such, if the surface is considerably smooth, the ray of light consistently reflects off the surface at the same angle, therefore creating a specular reflection (e.g., a mirror-like reflection of light from the surface). An example of a surface with high specular reflectance is a mirror, which reflects all components of the light almost equally and the reflected specular light follows the same angle from the normal angle, as does the incident light. On the contrary, the microstructure of reflective curtain 100 allows for the incident light to be dispersed in various angles depending on which specific location of the surface the light is reflected.

One example of light dispersion can be achieved using a rough surface, such as that shown in FIG. 3A. The rough surface causes light to be reflected across a variety of different angles. Therefore, the diffuse light reflected from a rough surface travels in many different directions as shown in FIG. 3B. The surface may be roughed through various processing techniques, including lasing, etching, mechanical abrasion, calendaring, just to name a few. In some examples, the microstructure of the material itself is porous or micro-porous, and thereby exhibits diffuse light reflection. And, in various examples, a combination of the microstructure and surface modification such as those referenced above may be implemented in order to achieve a desired light dispersion characteristic.

For example, the material of the reflective curtain may be a polymeric membrane material with a high diffusive reflectance. The reflective curtain may be formed of, or otherwise include microporous, conformable, and light reflective materials. In some embodiments, the reflective curtain is formed of an expanded fluoropolymer material, such as expanded polytetrafluoroethylene (ePTFE). The material of the reflective curtain may generally be in the form of a membrane, or thin film that is relatively conformable, or drapeable. Though ePTFE is an example of a suitable material, the reflective curtain may include other types of expanded polymers, such as expanded polyethylene (ePE). For example, the reflective curtain may include one or more layers of ePE, such as gel-processed ePE, which may have a score of approximately 40-45% reflectance from 400 to 700 nm, respectively. The one or more ePE layers may be relatively thin (e.g., less than 0.500 mm) and strong, and be conformable and insulative.

In some embodiments, the reflective curtain includes a plurality of layers, which may have differing properties (e.g., thickness, permeability, reflectivity, diffusivity, hydrophobicity or hydrophilicity, or others). As such, the layers may be arranged to modify one or more characteristics of the reflective curtain, such as transmissivity, reflectance, air and/or water or water vapor permeability, or other characteristic. For example, some examples include a first layer of ePTFE film (e.g., less than 0.500 mm thick) and a second layer of ePE film (e.g., less than 0.500 mm thick). The second layer of ePE film may be implemented as a backer layer, for example.

FIG. 3C shows an ePTFE membrane reflective curtain by way of example, which includes a fibrillated microstructure (comprising a plurality of fibrils interconnecting a plurality of nodes as shown) which refract light. Though a relatively large nodal structure is shown in FIG. 3C, some microstructures include highly fibrillated, or essentially nodeless structures as desired.

For reference, the term “refraction” pertains to a change in direction of the light waves when they bounce off a surface. In various examples provided herein, the fibrils comprising the fibrillated microstructure change the direction of incoming light, which may redirect light to other nearby fibrils, which may be redirected to additional nearby fibrils, and so forth. As the fibrils continue refracting the light beam amongst themselves, the fibrils may be said to cause the light beams to “bounce around” within the confinement of the enclosure formed by the membrane.

As reference above, FIG. 3C shows a scanning electron microscope (SEM) image of the surface of a membrane material formed of ePTFE that may be utilized for the reflective curtain 100 and which may be implemented to achieve a diffuse reflection characteristic of the reflective curtain. In some examples where ePTFE or materials with similar microstructures are employed, light beams refract from fibril to fibril so that the depth and openness of the microstructure coupled with a high fibril density allow for a maximum amount of refraction within the microstructure. Aside from ePTFE membranes, other suitable expanded polymers with similar properties may be used as well. In some examples, the microstructure of the material includes features (e.g., fibrils) which are aligned or otherwise oriented to gather, or collect light, such that the resulting reflected light beams are concentrated to a desired location, such as the center of the enclosure formed by the reflective curtain.

In some examples, the ePTFE film is a relatively nodal microstructure with the fibrils orientated in one axis of the film. In some embodiments, the film has the following properties: mass/area: 329 g/m²; thickness: 0.028 in (0.711 mm); density: 0.46 g/cc; and porosity: 79%. Mass per unit area may be calculated by dividing the mass of a sample (obtained by weighing the sample in a balance, Mettler E163) by its surface area. The reported values may be obtained by the average measurements for five samples. Thickness may be measured using a snap gage (Mitutoyo Model, 547-400, 0.25″ diameter foot, made in Aurora, Ill.). The reported values may be obtained by the average measurements for five samples. Density may be calculated by dividing the mass of a sample (obtained by weighing the sample in a balance as described above) by its volume (obtained by multiplying the area of the sample and its thickness). The reported density values may be obtained by averaging measurements for five samples. Porosity may be expressed in percent porosity and determined by subtracting the quotient of the average density of the article and that of the bulk density of PTFE from 1, and then multiplying that value by 100%. For the purposes of this calculation, the bulk density of PTFE may be taken to be 2.2 g/cc.

Additional examples of suitable ePTFE films for use as reflective curtains according to the embodiments described herein may be found in U.S. Pat. No. 5,596,450 to Hannon et al., filed Jan. 6, 1995 (the '450 Patent). Though primary examples in the '450 Patent relate to thicknesses of 0.500 mm or greater, in various examples according to the reflective curtains addressed herein may be less than 0.500 mm thick (e.g., from 0.100 to 0.400 mm thick). Such lower thicknesses may achieve greater conformability and drapeability, which may be desirable as described below. Moreover, it may be desirable to incorporate relative lower densities, such as less than 0.50 g/cc (for example 0.46 g/cc according to the foregoing example above).

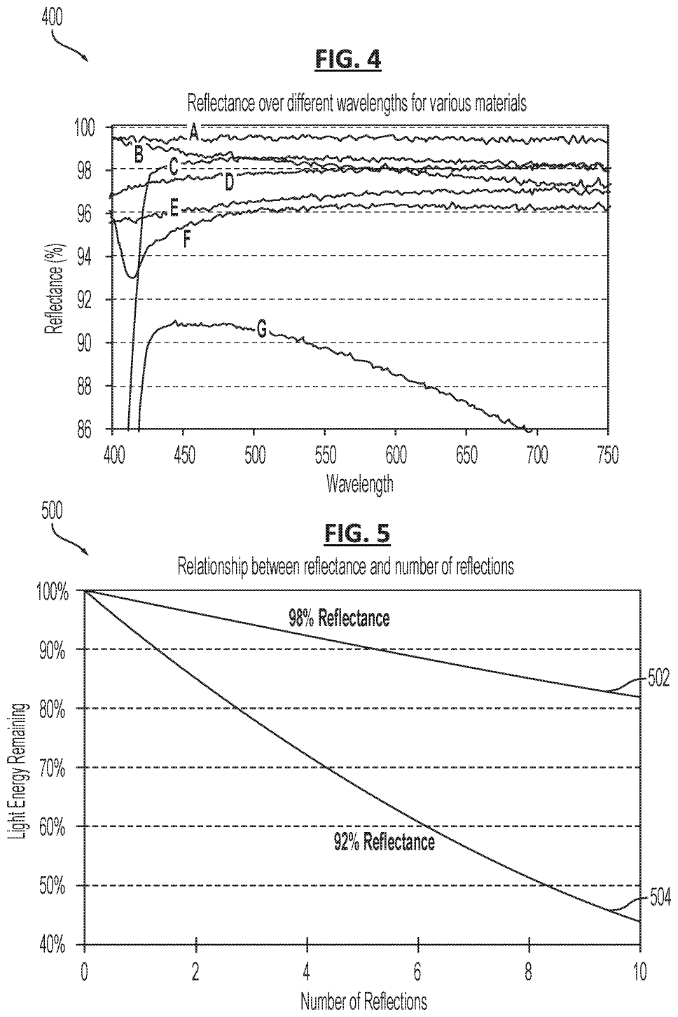

FIG. 4 shows a graph 400 comparing the reflectance values of various materials which can be used for the reflective curtain 100 over different wavelengths of visible light (e.g., spectral-specific variance). It should be noted that the range of 400 nm to 750 nm encompasses the range of wavelengths for visible light, with violet in the low end and red in the high end. Line A in the graph 400 represents a reflective curtain including a reflector membrane made of expanded polytetrafluoroethylene (ePTFE) having a thickness of 3 mm. Line B represents another reflector membrane made of ePTFE with a thickness of 0.5 mm. Line C represents yet another reflector membrane made of ePTFE with a thickness of 0.25 mm. Lines A through C represent just a few of the possible embodiments of the reflective curtain 100.

For sake of comparison, additional reflectance patterns are shown for other types of materials. Line D represents a reflective surface made of granular polytetrafluoroethylene (PTFE). Line E represents a reflective surface made of barium sulfate. Line F represents a reflective surface made of microporous polyester. And finally, Line G represents a reflective surface made of powder coating on a substrate.

Based on the materials A through G (represented by their respective lines A through G in graph 400) and their reflectance over various wavelengths, it is possible to compare their efficiency when used as the material for the reflective curtain 100. For example, Line A shows that the ePTFE reflector with at thickness of 3 mm is constantly above all the remaining lines with a reflectance at or above 99%, which surpasses any other material in the graph. Line B shows that the ePTFE reflector having a thickness of 0.5 mm starts at the same level of reflectance as material A at 400 nm wavelength, but gradually decreases to around 97% reflectance at 750 nm. Line C shows that the ePTFE reflector having a thickness of 0.25 mm starts at very low reflectance of below 86% at 400 nm wavelength, but increases to above 98% at 450 nm, where it stays within 450 nm to 750 nm wavelengths. Line D shows that granular PTFE remains from 96% to 98% reflectance throughout the graph. Lines E, F, and G get progressively less reflective, with line G showing that the powder coating achieves a reflectance of above 90% only from roughly 430 nm to 540 nm.

FIG. 5 is a graph 500 indicating the relationship between the reflectance of a material to the number of reflections that can be achieved. Every time a ray of light reflects, some of the light energy is lost. If an optical design causes more than one reflection to occur, a poor reflector can absorb a significant amount of total energy. Therefore, a small difference in reflectance can make a large difference in the total light output. For example, line 502 shows a material that has a 98% reflectance. This material may be material B (ePTFE at 0.5 mm thickness) or material D (granular PTFE) at the wavelength of approximately 600 nm, according to FIG. 4. Initially, before any reflection takes place, the amount of light energy remaining is 100%. By the time 20% of the light energy has been spent, this material achieves 10 reflections. On the other hand, for a material that has only a 92% reflectance, such as represented by line 504, by the time 20% of the light energy has been spent, this second material only achieves 2 reflections. As such, it can be seen that using the same amount of energy, the first material represented by line 502 achieves more reflections than the second material represented by line 504 by the time 20% of the light energy has been spent. The importance of this graph lies in that higher reflectance means lower transmittance, i.e. less energy escapes through the surface when light reflects off the surface. Therefore, higher reflectance leads to more yield producing light based on the same amount of initial energy.

Some of the embodiments in the present disclosure pertain to the use of a highly reflective material in the form of reflective curtain 100 surrounding a plant to form an enclosure and allow light from the light source to be reflected within the enclosure. The enclosure can be like the one depicted in FIG. 2 where the shape of the enclosure is rectangular, and the plant is surrounded by the reflective curtain 100. For reference, although the term “reflective curtain” is used in the singular, it should be appreciated that the reflective curtain 100 may be formed of a single, continuous piece of material, several discrete, individual segments of material, or separate but connected segments of material. In another example, the shape of the enclosure formed by the reflective curtain 100 may have any shape, such as, but not limited to circular, elliptical, polygonal, triangular, trapezoidal, or hexagonal, depending on the layout in which the plants may be arranged such that the shape of the enclosure maximizes total number of plants that can be placed within a certain area. In another example, the layout is determined to maximize the overall yield that can be obtained with fewer plants. This may be achieved by, for example, placing each plant in an equal distance from its neighbors, to provide ample space for each plant to grow without having the leaves of its neighbors interfering in its growth.

In another embodiment, the reflective curtain 100 may be a soft material that drapes over the plant that is receiving the light, covering the periphery of the plant to prevent foreign particles from entering the enclosure. In another example, the reflective curtain 100 may be more rigid (e.g., including one or more reinforcement members) and forms a container in which the plant is placed (e.g., the reflective curtain 100 may define a bottom and/or a side surface to support the plant).

The maximum reflectance of the inner wall of the enclosure may be 90% or higher, 95% or higher, 97% or higher, 98% or higher, or 99% or higher depending on the material that is used. In some embodiments, the maximum reflectance of the inner wall is from about 90% to about 95%, from about 95% to about 97%, from about 97% to about 98%, from about 98% to 99%, or from about 99% to about 99.5%. In some embodiments, an average reflectance of the inner wall is from about 90% to about 95%, from about 95% to about 97%, from about 97% to about 98%, from about 98% to 99%, or from about 99% to about 99.5%.

In some examples as discussed herein, the material used for the reflective curtain 100 is ePTFE membrane, where the microstructure thereof is designed to not only to reflect but also to diffuse and/or selectively allow certain wavelengths to pass therethrough. Referring to material A in graph 400, the reflectance is consistently at or above 98% throughout the entire visible spectrum. Therefore, as explained above, in graph 500, material A can achieve at least 10 reflections while using 20% of the total light energy from the light source, thereby increasing the total light output as compared to materials E, F, and G, which never achieve 98% reflectance at any wavelength. One advantage of using a highly reflective material such as ePTFE membrane for the reflective curtain 100 may be that the same luminescence may be achieved with lower wattage light bulbs than would otherwise be required, which may also reduce cost because of lower energy usage. For example, by using the highly reflective material to reflect light from a lower wattage light bulb throughout the enclosure, a user may achieve the same or similar luminescence as would be realized when a higher wattage light bulb is used to directly luminate the area within the enclosure. Another advantage is that the state of receiving light from all directions is generally more similar to how a plant normally receives light in a natural, outdoor setting. As just one example of differences between a natural setting and one in which artificial growing environments are used, in nature, wind moves plant leaves around to allow for different parts of the plant to be irradiated with sunlight so that lower vegetation can get glimpses of sunlight as well. However, since there is no wind in typical indoor agricultural setting without using an indoor fan, using and actuating movement into the reflective curtain 100 helps provide light throughout the growing environment for the plant to receive.

Referring to material C in graph 400, the initial reflectance at 400 nm is much lower below 86% reflectance, and this indicates that any light with a wavelength below 400 nm can be effectively prevented from being reflected. In other words, ultraviolet (UV) radiation which occupies the wavelength range of up to 400 nm would not be absorbed by the plant within the enclosure. As previously mentioned, UV radiation can be harmful to plants, so it may be advantageous to limit their exposure to such rays. Therefore, the use of material C in graph 400 in the reflective curtain 100 is one example in which ePTFE membrane can be used to selectively allow certain wavelengths to pass through the reflective curtain 100 to the outside of the enclosure so that these wavelengths are not reflected back to the plant. Alternatively, the reflective curtain 100 can be adjusted so that the reflectance at certain wavelengths can be less than, or greater than, the reflectance at other wavelengths. Advantages of this adjustable property includes the ability to exclude wavelengths that may promote mold or weed growth from being reflected inside the enclosure. The ePTFE microstructure can be manipulated in many ways, such as by choosing the correct resin, adjusting the processing parameters, as well as varying the expansion rates and thickness thereof. For example, U.S. Pat. No. 3,953,566 to Gore filed Jul. 3, 1973 describes numerous methods to modify such polymers to achieve different microstructures. Alternatively, two or more ePTFE membranes may be laminated together to achieve desired results as well. Laminated membranes can also be used as a light deterrent, since it is known that plants also need a given amount of complete darkness to thrive. If the light source is flammable, the physical properties of the ePTFE membranes can also be manipulated to be nonflammable. It should be noted that other suitable expanded polymer membranes with similar reflective properties as ePTFE membranes may also be employed.

A minimum reflectance of the inner wall at a wavelength range that is selectively allowed to pass (i.e. transmitted and therefore not reflected) may be at least 50%, at least 60%, at least 70%, at least 80%, at least 85%, or at least 90% lower than a maximum reflectance at a wavelength range that is to be reflected. In some embodiments, the minimum reflectance at the wavelength range that is selectively allowed to pass is from about 50% to about 60%, from about 60% to about 70%, from about 70% to about 80%, from about 80% to about 85%, from about 85% to about 90%, or from about 90% to about 95% lower than the maximum reflectance at the wavelength range that is to be effectively reflected. The wavelength ranges that are selectively allowed to pass (and therefore not reflected) as mentioned in the embodiments may be from about 280 nm to about 380 nm, from about 380 nm to about 450 nm, from about 450 nm to about 495 nm, from about 495 nm to about 570 nm, from about 570 nm to about 590 nm, from about 590 nm to about 620 nm, from about 620 nm to about 750 nm, or from about 750 nm to about 1 mm. In some embodiments, multiple ranges may be selected such that two or more non-neighboring ranges of the spectrum are to be selectively allowed to pass. For example, the ranges of from about 280 nm to about 380 nm, from about 495 nm to about 570 nm, and from about 750 nm to about 1 mm may be allowed to pass without being reflected, or being reflected at a reduced rate, by the reflective curtain 100 because the electromagnetic radiation of these ranges may be either harmful to the growth of a plant or does not affect the growth of the plant because the plant does not absorb such radiation. Such ranges may be adjusted depending on the type of plant that is being grown.

In addition to the above, reflective curtains formed from ePTFE membrane have advantages such as adjustable porosity. Advantages in having flexible porosity is that liquid and gas can be permeated through the pores at around the standard atmospheric pressure to allow for better breathability of the plant. Because plants need carbon dioxide to grow, the pores can be adjusted to allow carbon dioxide to pass through as needed without letting particles from the outside to contaminate the inside of the enclosure. Also, dust attached to the surface of the reflective curtains can reduce reflectance of the curtains, so the pores can be used to occasionally let gases pass through to remove any particles that may be attached to the curtains. In one example, pressurized carbon dioxide gas can be used to push the particles off the surface. Because carbon dioxide is denser than air, the carbon dioxide will sink to the bottom surface on which the plant is located (for example, a table or a tray), causing the particles to settle on the bottom surface and away from the curtains.

In another example, the reflective curtain can have a porosity sufficient to allow water vapor to pass through in order to minimize the condensation formed on the curtain surface. Furthermore, besides carbon dioxide, other gases can be beneficial to plant growth. For example, small doses of hydrogen sulfide can greatly enhance plant growth, and ethylene can stimulate the ripening of fruits. The porosity of the ePTFE membrane can be adjusted to allow such gases to enter the enclosure, as necessary.

Other advantages of using ePTFE membrane as the material for the reflective curtain include its resistance to oxidation and degradation. Because ePTFE membrane is chemically inert to nearly all media ranging from pH levels of 0 (maximum acidity) to 14 (maximum alkalinity), has a wide range of thermal resistance from −268° C. to +315° C., and is physiologically inert, the ePTFE reflective curtains can tolerate the heat output of indoor lighting system for a prolonged period without degrading or melting.

As shown in graph 400, properties of the ePTFE membrane used in the reflective curtain such as the reflectance may depend on the thickness of the ePTFE membrane being used for the inner wall. The thickness may range from about 0.01 mm to about 1 mm. In some embodiments, the thickness is from about 0.01 mm to about 0.05 mm, from about 0.05 mm to about 0.1 mm, from about 0.1 mm to about 0.25 mm, from about 0.25 mm to about 0.5 mm, from about 0.5 mm to about 0.75 mm, from about 0.75 mm to about 1 mm, or greater than 1 mm. It is to be noted that the thickness of the ePTFE membrane can be adjusted to meet various requirements as set forth by the user, such as the weight of the reflective curtain and the amount of conformability, or drapeability of the reflective curtain. Because reducing the thickness also reduces weight of the curtain, the user may opt for the thinnest version of the ePTFE membrane which weighs less but still provides ample reflectance sufficient for the purposes of the reflective curtain. In some examples, the reflective curtain may have sufficient conformability, drapeability, and lightness such that the plant itself may be capable of adjusting the position of the reflective curtain. That is, when the plant grows past a certain height or size, the plant may be able to push the reflective curtain beyond its initial position such that the reflective curtain drapes over some of the outer leaves of the plants.

In some embodiments, the reflective curtain 100 may be metalized and/or printed with metal, or conductive metal traces. The metal traces can be used to allow LEDs or other light sources to be installed onto a pliable, conformable, and reflective substrate (e.g., ePTFE membrane), thereby enabling the LEDs to be installed directly on the curtain. For example, LED light(s) may be installed on the inner wall of the reflective curtain 100 such that the LED light(s) shines directly onto the plant. In such embodiments, the space between the curtain and the light source is eliminated thus forming a more sealed enclosure. One advantage of such sealed enclosures includes added protection. In addition, maximizing the amount of light that is being reflected by eliminating space that may result from a configuration in which the LED lighting is placed direct above an opening of the curtain surrounding the plant is another advantage. Furthermore, in other examples, the reflective curtain 100 is compliant and flexible. FIG. 8 shows an example of such sealed enclosure.

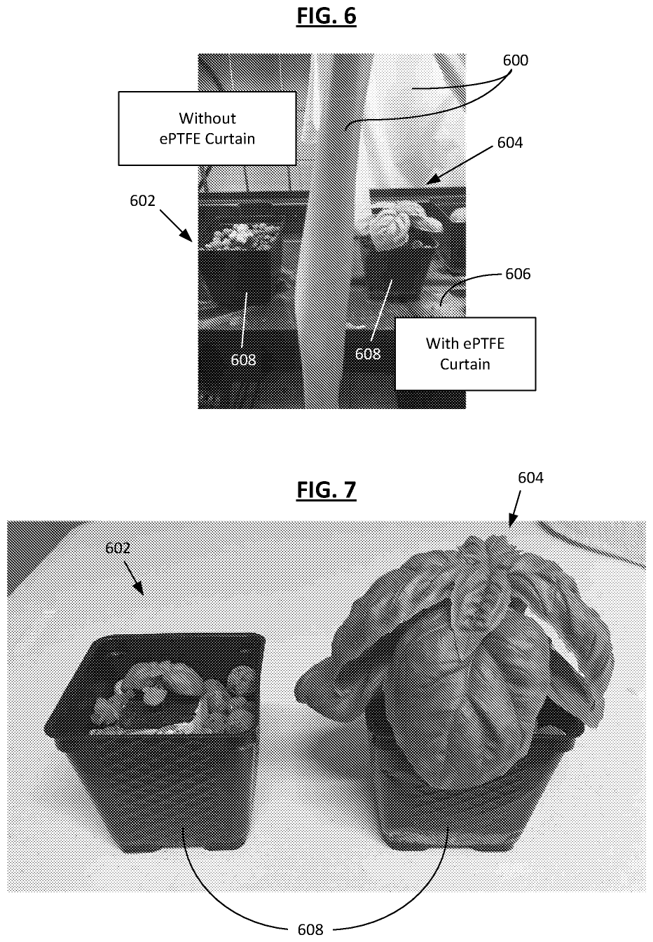

FIGS. 6 and 7 show the results of an experiment conducted using a reflective curtain as disclosed herein to illustrate the difference between two plants of the same type (Basil), grown under the same conditions, with the exception that one of the plants is surrounded by an ePTFE reflective curtain and the other plant is left outside the reflective curtain. FIG. 6 shows a reflective curtain 600 that surrounds a sample plant 604 while another sample plant 602 is positioned on the other side of the curtain 600. In this arrangement, the same type of seed was grown in the same growth medium, at the same time, under the same light source and in a tray flooded with the same nutrient solution at the same time of the day. The sample plant 604 was able to receive more light that was reflected off the inner wall of the reflective curtain 600. As shown in FIG. 7, the plant 604 grew considerably more than the sample plant 602 that only received light from the above, and little, if any, of the reflected light.

The growth experienced by each plant can be measured by the amount of biomass for the same amount of time and lighting energy use. In this case, the biomass is largely comprised of the surface area of the leaves of the plants. It should be noted that a tray 606 on which the plants were placed and containers 608 for the plants used in the above experiment were both black, therefore absorbing some of the light that could have been utilized by the plants. In some implementations of these embodiments, reflective containers and trays, such as those with silver coating or wrapped with a sheet of aluminum, can be used so that the containers and trays reflect light back to the leaves of the plant, to further assist photosynthesis of each plant. Further, the tray 606 and container 608 may also be laminated with the reflective curtain.

FIG. 8 shows another example of a setup or system for indoor agriculture implementing the reflective curtain 100 and the light sources 102 to grow a photosynthetic organism 104, which in this case may be a plant. As shown, the reflective curtain 100 has two opposing sides, a first side 100A and a second side 100B, where the plant 104 is placed on a surface 806 or is otherwise maintained in position therebetween. In some examples, there are a plurality of light sources, such as: a first set of light sources 102A is attached or implemented in a ceiling 804 located above the plant 104, a second set of light sources 102B is coupled to or otherwise implemented with the first side 100A of the reflective curtain 100, and a third set of light sources 102C is coupled to or otherwise implemented with the second side 100B of the reflective curtain 100.

In some examples, one or more of the aforementioned light sources 102A, 102B, 102C may be removed from the setup according to the different needs of the plant 104 (for example, some plants may require more of the light from the side than from the above, so the light sources 102B and 102C may be more preferred than the light source 102A on the ceiling). The light sources as described herein may be any suitable artificial light source, such as fluorescent grow lights, HPS or HID grow lights, and LED grow lights, to name a few. Furthermore, the light sources may be ultralight and ultrathin to enable the reflective curtain to freely move about in the presence of wind or ventilation.

In some examples, the light sources 102 may be fixed, attached, or otherwise coupled to the reflective curtain 100. For example, one or more of the light sources 102 may form an integral part of the reflective curtain 100. In some examples, the light sources 102 may be fitted within an opening made in reflective curtain 100. Furthermore, one or more of the light sources 102 may be controlled using a power source 802 (e.g., affixed to the ceiling 804 or elsewhere as desired). In some examples, the reflective curtain 100 is affixed or attached to the ceiling 804, or other structure, at one end 808 while being free to move on the other end 810. In some examples, the free end 810 of the curtain 100 may be in contact with the surface 806 to from an enclosure 812 from which water vapor cannot escape, but into which air from the surrounding environment may still enter. This is possible by controlling the permeability and hydrophobicity of the material (for example, a fluoropolymer membrane such as the ePTFE films previously described) that forms the reflective curtain 100.

In some examples, water vapor within the enclosure 812 may condense at the ceiling 804, or other structure, and/or an inner surface 814 of the reflective curtain 100. The condensed water vapor may then form droplets that translate downward by the force of gravity along the inner surface 814 of the reflective curtain 100. If the ground 806, or other surface, includes soil or other growth medium, the collected water droplets may then absorbed by the ground 806 to the benefit of the plant 104, without escaping to the external atmosphere. For reference, the term “ground” as used throughout this description is not meant to require an environmental, soil surface, but instead is used for convenience to refer to a lower surface or structure. Similarly, the term “ceiling” as used throughout this description is not meant to require a roof or building structure, but instead is used for convenience to refer to an upper surface or structure.

As previously indicated, the reflective curtain 100 may be relatively thin and conformable. The thickness of the reflective curtain 100 is measured as the distance between the inner surface 814 and an outer surface 814 thereof. As previously referenced, thickness may be measured using a snap gage (Mitutoyo Model, 547-400, 0.25″ diameter foot, made in Aurora, Ill.). The conformability or the flexibility of the reflective curtain 100 may be measured using test methods such as a drape test to determine drape coefficient of the reflective curtain 100, as known in the art. For example, a suitable drape test may include preparing a circular specimen of the reflective curtain 100 between two smaller concentric discs, and the exterior ring of the reflective curtain 100 is allowed to drape into folds around the lower supporting disc. The shadow of the draped reflective curtain 100 is cast from below onto a ring of paper of known mass having the same size as the unsupported part of the reflective curtain 100. The outline of the shadow is traced onto the ring of paper and the paper is then cut along the trace of the shadow. The drape coefficient may be characterized as the mass of that part of the paper ring representing the shadow, expressed as a percentage of the mass of the whole paper ring. In some examples, the reflective curtain 100 may have a drape coefficient of less than about 0.4, less than about 0.3, less than about 0.2, less than about 0.1, or less than 0.05, in order to achieve a suitable level of conformability and flexibility.

In some examples, the conformability or flexibility of the reflective curtain 100 helps the reflective curtain 100 scatter more light throughout different sections within the enclosure 812. For example, when the reflective curtain 100 is rigid, the light is supplied to the same sections of the plant 104 unless the light source 102 is moved or switched to direct light from other angles.

In some examples provided herein, a conformable reflective curtain may facilitate the use of relative static light source angles, or may further enhance the efficacy of changing light source angles, by facilitating deformation of the reflective curtain 100 under environmental conditions. When the reflective curtain 100 is sufficiently conformable or flexible, the reflective curtain 100 is capable of moving in the presence of positive air pressure (e.g., wind or ventilation) which may occur naturally or artificially (via artificial ventilation). As the reflective curtain 100 moves, the surface angle of the reflective curtain 100 with respect to the light sources, ground 806, and plant 104 changes, and the change in these angles changes the directions in which light is scattered by the inner surface 814 of the reflective curtain 100. As such, a flexible reflective curtain 100 may result in a more effective distribution of light (e.g., a more uniform distribution) over more of the plant 104 than a more rigid surface.

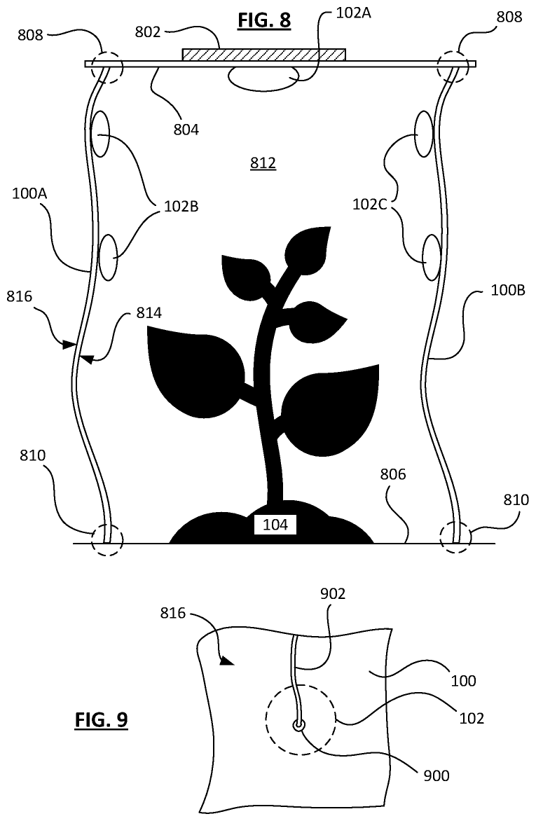

FIG. 9 shows an example of how the light source 102 (which may be either the light source 102B or light source 102C as shown in FIG. 8) may be mounted on the reflective curtain 100 according to an embodiment. The light source 102 may be attached or otherwise coupled to the inner surface 814 of the reflective curtain 100 using any suitable means including but not limited to gluing, taping, bonding, and adhering. As shown, the reflective curtain 100 has an opening 900 that provides a path for a conductive trace array 902 located on the external surface 816 of the reflective curtain 100 to reach the light source 102 on the inner surface 814 through the reflective curtain 100. As such, the conductive trace array 902 may remain on the outside the enclosure 812 and therefore away from the water vapor and condensation which may form on the inner surface 814 of the reflective curtain 100. In some examples, the conductive trace array 902 may be covered using a nonconductive polymer or other protective layer, in which case the conductive trace array 902 may be located on the inner surface 814 and therefore the opening 900 in the reflective curtain 100 may no longer be required. The conductive trace array 902 enables the light source 102 to receive the energy needed to active, and in some examples to also send signals to the power source 802, which may be connected to a processing unit such as a computer, when the light source 102 deactivates or fails to activate.

In some examples, a conductive circuit and LED attachment to the reflective curtain 100 may include the following. A piece of reflective curtain material (e.g., ePTFE) may be manufactured according to any of the foregoing examples using, e.g., the process taught in U.S. Pat. No. 5,476,589 to Bacino filed Mar. 10, 1995. The material may be in the form of a film. A mask may be applied to the film for accurate application of a metallic ink (which may include, for example, copper, aluminum, bronze, zinc, or any other conductive metal alloy) in a dual conductive trace pattern. The dual conductive trace pattern may be defined by having the trace pattern defining a conductive path from an energy source to an energy sink as well as another conductive path from the energy sink back to the energy source. Suitable ink may be acquired from Ercon Inc. of Wareham, Mass., and may be applied using a variety of means, such as a screen printing techniques. The film, mask and ink may be cured or dried (e.g., in an air convection oven set at 65° C.). Once dry, the mask may be removed and the LEDs are attached to the conductive traces (e.g., at about 50 mm increments). The same ink as used for the traces may be used to attach the LEDs. Suitable LEDs may be acquired from Luminus Devices Inc. of Sunnyvale, Calif., for example, including those sold with part number 1214-1447-1-ND. The construct, formed by applying the LEDs and the traces to the film, may then be dried, in a similar manner to that previously described.

In some examples, polyurethane adhesive may be applied on a film layer and then transferred onto another film layer (e.g., the same type of film as that onto which the traces are formed) using a suitable method (e.g., a standard heat press machine, such as the one used to press patterns and designs on to t-shirts, set to 130° C.). A silicone adhesive (e.g., P/N MED 1137, available from Nu-Sil Corporation of Carpenteria, Calif.) may be applied at the location of each LED. The silicone adhesive may be thinned prior to application using heptane (or any other suitable solvent) and applied using a syringe or any other suitable delivery mechanism. The syringe may be used to apply droplets of the polyurethane adhesive and/or heptane onto a surface as suitable to create “dots” of polyurethane adhesive and silicone adhesive on the surface of the film. The ePTFE film with polyurethane adhesive dots may be placed on the ePTFE film and circuit construct (including the traces) such that the polyurethane adhesive dots are facing the LEDs. The entire construct may then be bonded (e.g., placed in the heat press machine again with both sheets fused together by re-flowing the polyurethane adhesive therebetween for 30 seconds).

In various examples, the use of heptane in the silicone may assist in wetting the ePTFE film at the location of the LED(s), thereby clarifying the material (i.e., making the material more light-transmissive) to allow light to pass through the reflective curtain material. In the foregoing assembly, the entire LED circuit may be sandwiched in soft, thin, conformable and reflective ePTFE film, while providing insulation to the conductive traces. Each LED may be at a location where the ePTFE film was wet with silicone and heptane such that the wetted locations of the ePTFE film are more transparent than the rest of the ePTFE film that was not wetted with silicone and heptane. In some examples, the droplets of silicone may be modified through surface tension or use of a form or tool to change the silicone layer into a lens at the location of the LED, thereby changing the angles at which photonic energy is directed from the LED.

The foregoing example of LED coupling is provided for illustrative purposes only, and any of a variety of mechanisms for providing a conductive trace array to the reflective curtain 100, light source (e.g., LED) coupling to the reflective curtain 100, and selective light transmission through the reflective curtain 100 at the light source(s) are contemplated.

Besides indoor agriculture, the reflective curtain 100 may be used in an outdoor environment as well. For example, greenhouses require a film to cover the outer structure to protect the plants inside from the outside elements. The outer structure can be of various shapes, such as gunner connected, free standing Quonset, and single gable structures to name a few. Different numbers of sidewall and ceiling portions may be employed to form the various greenhouse structure configurations. Use of reflective curtains as the architectural fabrics, such as ePTFE architectural fabrics forming the roof or sidewalls of the greenhouse, can add an advantage to the construction of the greenhouses in that the reflective curtains can be adjusted to manipulate UV wavelengths that can pass through the fabric forming the greenhouse. Also, in the example of ePTFE architectural fabrics, the fabrics are UV-stable and do not degrade over time under exposure to UV rays. The ePTFE architectural fabrics have high durability and breathability in addition to reflectivity, and the fabrics can also be windproof, waterproof, and fire-retardant. This and additional or alternative advantages and benefits may be realized in using ePTFE fabrics and/or membranes in greenhouses.

Outside the field of indoor agriculture, reflective curtains can be used in any field of science where efficient lighting is needed in a clean environment. Some examples include, but are not limited to: medical device facilities, electronics fabrication facilities, and pharmaceutical facilities. In any of these facilities, the use of reflective membranes to reflect light can save considerable amount of energy, especially if these facilities are large and require more light than smaller facilities. Therefore, more light can be obtained for the same wattage, or the same amount of light can be obtained for less wattage. Also, because many of these facilities utilize clean rooms where the number of outside contaminants must be kept to a minimum, the porosity, and therefore breathability, of the reflective curtain is important because there would be constant ventilation to blow any dust or particle away from the products that need to be maintained clean. Blowing air or other gases through the reflective curtains can also help keep the inside of the enclosure clean without needing to remove the reflective curtain to do so. In one example, the curtain is a self-cleaning reflector in that the curtain is coupled to a pressurized air source, for example, a programmable electric air blower, operably associated with the curtain such that the air source delivers pressurized air through the curtain to clean the enclosure at a predetermined interval. In another example, the air source may constantly blow air through the curtain to keep the enclosure clean at all times.

Further, reflective curtains made of reflective membranes may also be used in the emerging field of space farming, where studies are performed to see how crops can be cultivated for food and other material in space, or an extraterrestrial location. Extraterrestrial locations can include a space station or space colony, or the surface of a distant planet (e.g. Mars) or satellite (e.g. the Moon) away from Earth. One of the challenges faced by researchers in this field is that the amount of sunlight provided to the crop in such environments may be considerably less than what is available on Earth. Considering the limited energy source that must be used for other life-sustaining purposes such as providing water and air to the environment, farmers in this environment cannot depend on artificial lighting to provide all the light necessary for the growth of the crops. Insufficient availability of light causes limited photosynthesis to take place, which results in fewer crops for cultivation or a decrease in the crops' biomass. To have a fully sustainable crop source, the reflective membranes can be used to gather as much of the available light, natural and artificial, and reflect the light in a way that maximizes the amount of light received by the crops.

Besides the reflectivity of the membranes, the size of the pores therein can also be adjusted as needed. For example, in an agricultural environment, having the membranes be permeable to air, water vapor, and carbon dioxide may be an important factor when considering the porosity of the membranes. In some examples, the size of the pores may be small enough to allow air in but prevents water vapor from passing through the membranes to maintain a dry environment, which may be especially important for facilities specializing in microfabrication or nanofabrication, where even a small amount of water contamination causes problems such as short-circuiting of microdevices. The pores of the membrane may be adjusted to be selectively permeable to certain substances at or around the standard atmospheric pressure of 1013.25 mbar. The typical range of atmospheric pressure in which these membranes remain permeable may be from about 980 mbar to about 1040 mbar.

Additionally, light depravation can affect the human personality over time, and many architects now consider bringing more outdoor light into the structures they design. Historically, natural light could only penetrate a building as far as the “line of sight” allowed, so there were areas that did not receive any natural light. Therefore, the reflective curtains as disclosed herein can help the light penetrate and saturate such areas of a dwelling that typically see no natural light, preventing the negative effects associated with light deprivation.

Inventive concepts have been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A controlled environment agriculture system, the system comprising:
a reflective curtain including a porous membrane having a reflectance value of at least 90%.

2. The controlled environment agriculture system of claim 1, further comprising a light source and a photosynthetic organism arranged to receive light from the light source that is diffused by the reflective curtain.

3. The controlled environment agriculture system of claim 1, wherein the membrane is permeable to air at an atmospheric pressure from about 980 mbar to about 1040 mbar.

4. The controlled environment agriculture system of claim 1, wherein a first average reflectance value of the membrane at a first wavelength range from 400 nm to 450 nm is lower than a second average reflectance value at a second wavelength range from 450 nm to 750 nm.

5. The controlled environment agriculture system of claim 1, wherein the reflectance value of the porous membrane is at least 95%.

6. The controlled environment agriculture system of claim 5, wherein the reflectance value of the porous membrane is at least 98%.

7. The controlled environment agriculture system of claim 1, wherein the membrane comprises an expanded fluoropolymer.

8. The controlled environment agriculture system of claim 7, wherein the expanded fluoropolymer is an expanded polytetrafluoroethylene.

9. The controlled environment agriculture system of claim 1, further comprising at least one light source operably arranged proximate the reflective curtain such that light is reflected by the reflective curtain.

10. The controlled environment agriculture system of claim 1, wherein the reflective curtain forms an enclosure configured to cover a photosynthetic organism.

11. The controlled environment agriculture system of claim 3, wherein the membrane is also permeable to at least one other gas.

12. The controlled environment agriculture system of claim 11, wherein the other gas comprises at least one member selected from hydrogen sulfide, ethylene and combinations thereof.

13. The controlled environment agriculture system of claim 1, wherein the reflective curtain has a thickness from 0.100 mm to 0.400 mm.

14. The controlled environment agriculture system of claim 1, wherein the reflective curtain has a drape coefficient of less than 0.4.

15. The controlled environment agriculture system of claim 1, wherein the reflective curtain has a density of less than 0.50 g/cc.

16. The controlled environment agriculture system of claim 9, wherein the at least one light source is disposed on the reflective curtain, the reflective curtain further comprising at least one conductive trace array disposed thereon and operatively coupled with the at least one light source.

17. The controlled environment agriculture system of claim 16, wherein the reflective curtain comprises two reflective layers at least partially bonded to each other, and the at least one light source and the at least one conductive trace are disposed between the two reflective layers of the reflective curtain.

18. The controlled environment agriculture system of claim 16, wherein at least one location on the reflective curtain is more transparent than the rest of the reflective curtain, and the at least one light source is disposed at the at least one location.

19. The controlled environment agriculture system of claim 16, wherein at least one location on the reflective curtain forms a lens, and the at least one light source is disposed at the at least one location.

20. A method of assembling a controlled environment agriculture system, the method comprising:
arranging a reflective curtain including a porous membrane having a reflectance value of at least 90% adjacent a plant; and
operating a light source to provide light that is reflected from the reflective curtain to the plant.

21. The method of claim 20, wherein operating the light source includes powering a light source included in the reflective curtain.

22. The method of claim 21, wherein the reflective curtain comprises at least one conductive trace array on a surface of the reflective curtain, the at least one conductive trace array operatively coupled with the light source.

23. The method of claim 21, the reflective curtain further comprises a first layer and a second layer at least partially bonded to each other such that the light source is disposed between the polymer film layer and the reflective curtain.

24. The method of claim 23, wherein a surface of at least one of the first and second layers is substantially transparent at a location where the light source is disposed.

25. The method of claim 20, wherein arranging the reflective curtain includes draping the reflective curtain such that ambient, positive pressure air flow causes the reflective curtain to deform and modify a surface angle of the reflective curtain relative to the plant.

26. The method of claim 25, wherein modifying the surface angle of the reflective curtain changes directions in which light is reflected or scattered by the reflective curtain.

27. A method of making a reflective curtain, the method comprising:
applying at least one conductive trace array on a surface of a first film having a reflectance value of at least 90%;
disposing a light source on the surface of the first film, the at least one conductive trace array operatively coupled with the light source;
applying adhesive on a surface of a second film; and
forming the reflective curtain by at least partially bonding the surface of the first film with the surface of the second film such that the light source is disposed between the first and second films.

28. The method of claim 27, further comprising:
wetting the surface of the polymer film layer with a solvent, wherein the surface of the polymer film is wetted at a location where the light source is to be disposed when the polymer film layer and the reflective curtain are at least partially bonded.

29. The method of claim 27, wherein the reflective curtain has a thickness of from 0.100 mm to 0.400 mm.

30. The method of claim 27, wherein the reflective curtain has a drape coefficient of less than 0.4.

31. The method of claim 27, wherein the reflective curtain has a density of less than 0.50 g/cc.

32. A controlled environment agriculture system, the system comprising:
a reflective curtain including a porous membrane having a reflectance value of at least 80% and a drape coefficient of less than 0.4.

33. The controlled environment agriculture system of claim 32, wherein the reflective curtain has a thickness from 0.100 mm to 0.400 mm.

34. The controlled environment agriculture system of claim 32, wherein the reflective curtain has a density of less than 0.50 g/cc.

35. The controlled environment agriculture system of claim 32, further comprising a light source and a photosynthetic organism arranged to receive light from the light source that is diffused by the reflective curtain.

36. The controlled environment agriculture system of claim 35, wherein the photosynthetic organism is configured to change a position of the reflective curtain when the photosynthetic organism grows past a predetermined height or size.
